(19) United States
(12) Patent Application Publication
(10) Pub. No.: US 2018/0188936 A1
(43) Pub. Date: Jul. 5, 2018

(54) MULTI-USER BOOKMARKING OF MEDIA CONTENT

(71) Applicant: THOMSON Licensing, Issy-les-Moulineaux (FR)

(72) Inventors: Juan M. NOGUEROL, Gardena, CA (US); Tom Lindeman, Los Angeles, CA (US)

(21) Appl. No.: 15/738,728

(22) PCT Filed: Jun. 16, 2016
(86) PCT No.: PCT/US2016/037742

§ 371 Date: Dec. 21, 2017

Related U.S. Application Data
(60) Provisional application No. 62/186,062, filed on Jun. 29, 2015.

(51) Int. Cl. G06F 3/0484; G06F 17/30; G11B 27/34

(52) U.S. Cl. CPC G06F 3/04847; G11B 27/34; G06F 17/30852; G06F 17/30858

(57) ABSTRACT

Ways to generate and utilize bookmarks in association with media content are described. Each bookmark may be associated with a user (210 or 320). Bookmarks associated with multiple users may be provided via a user interface (UI) (200 or 300) that includes a list of users (210) and multiple sets of bookmark indicators (250 or 310), where each set of bookmark indicators is associated with a particular user (210 or 320). A viewer may select from the indicators (250 or 310) in order to utilize the associated bookmark. Such a selection may cause playback to proceed to a location within the media content that is associated with the bookmark. A viewer may further be able to add a bookmark using various UI features (240 or 340).

### BACKGROUND

Many consumers access multimedia content (e.g., video content) through various online services. Currently, content providers may provide a timeline that allows users to manually select specific points within the content.

Users may wish to share or otherwise draw attention to content sections such that others may easily be able to access those content sections deemed relevant or important. Such users may not be able to easily create bookmarks that may be used to automatically move to locations along the timeline. In addition, users may not be able to share, distribute, or retrieve such bookmarks within an environment shared by multiple other users.

Thus there is a need for a way for multiple users to easily generate bookmarks associated with online content and share the bookmarks with other users.

### SUMMARY

Some embodiments provide ways to present media content to viewers. The media content may be presented using various appropriate user interfaces (UIs). Such media content may be associated with various bookmarks or index points along a timeline. The bookmarks may be associated with selectable indicators such that a viewer is able to jump to the appropriate point along the timeline based on selection of a bookmark.

Each bookmark may be associated with a creator-user (or group of users). Bookmarks may be presented with identifying information (e.g., different colors) such that a viewer is able to ascertain the creator-user of each bookmark.

In some embodiments, a viewer may be able to select from among the users. Such selection may cause only bookmarks associated with the selected user to be displayed (and/or to otherwise highlight the bookmarks associated with the selected user).

Some embodiments provide ways to create bookmarks, associate the bookmarks to content items, and/or share or otherwise distribute the bookmarks to other users (and/or groups of user).

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates an exemplary user interface (UI) of some embodiments that provides ways for users to interact with a multi-user bookmark environment;

FIG. 2 illustrates an exemplary UI of some embodiments that provides creation and use of bookmarks;

FIG. 3 illustrates an exemplary alternative UI of some embodiments that provides creation and use of bookmarks;

FIG. 4 illustrates an exemplary UI of some embodiments that confirms bookmark creation;

FIG. 5 illustrates a schematic block diagram of a hardware system used by some embodiments to provide the multi-user bookmark environment;

FIG. 6 illustrates a schematic block diagram of a software system used by some embodiments to provide the multi-user bookmark environment;

FIG. 7 illustrates a flow chart of an exemplary client-side process used by some embodiments to generate a bookmark;

FIG. 8 illustrates a flow chart of an exemplary provider-side process used by some embodiments to generate a bookmark;

FIG. 9 illustrates a flow chart of an exemplary server-side process used by some embodiments to generate a bookmark;

FIG. 10 illustrates a flow chart of an exemplary client-side process used by some embodiments to utilize bookmarks within a multi-user bookmark environment;

FIG. 11 illustrates a flow chart of an exemplary provider-side process used by some embodiments to utilize bookmarks within a multi-user bookmark environment;

FIG. 12 illustrates a flow chart of an exemplary server-side process used by some embodiments to utilize bookmarks within a multi-user bookmark environment;

FIG. 13 illustrates a flow chart of an exemplary process used by some embodiments to generate a timeline for user with a multi-user bookmark environment; and

FIG. 14 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various inventive features are described below that can each be used independently of one another or in combination with other features. Broadly, some embodiments generally provide a way to define and utilize sets of bookmarks among groups of users and across multiple platforms. Such bookmarks (or “index points”) may define a time-based location (e.g., a point along a timeline) within some content item (e.g., a video or other media asset). In addition, each bookmark may include additional information related to various attributes such as creator, content source, distribution platform, audience, etc.

Bookmarks may be defined based on inputs received from multiple users. The bookmarks may be distributed or shared with other users. The distributed bookmarks may be provided in a single UI such that a viewer is able to select among multiple bookmarks from multiple users.

A first exemplary embodiment provides a method that generates a media asset timeline. The exemplary method can include generating a timeline comporting to a play length of the media asset, generating a first set of index points along the timeline, wherein the first set of index points is associated with a first user, and generating a second set of index points along the timeline, wherein the second set of index points is associated with a second user.

A second exemplary embodiment provides a user device that generates a media asset timeline. The exemplary user device can include a processor to executing a set of instructions, and a memory and/or non-transitory medium that stores the set of instructions. The set of instructions can include generating a timeline comporting to a play length of the media asset, generating a first set of index points along the timeline, wherein the first set of index points is associated with a first user, and generating a second set of index points along the timeline, wherein the second set of index points is associated with a second user.

A third exemplary embodiment provides a method that provides, at a server, bookmarked media content. The exemplary method can include receiving, from a user device, a request for a media content item, identifying, at the server, a set of users associated with the media content item, retrieving, at the server, for each user in the set of users, a set of index points along a timeline of the media content item, sending, to the user device, a response including the sets of index points, and providing, to the user device, the media content item.

A fourth exemplary embodiment provides a server that provides bookmarked media content. The exemplary server can include a processor for executing a set of instructions, a memory, and/or non-transitory medium that stores the set of instructions. The set of instructions can be receiving, from a user device, a request for a media content item, identifying, at the server, a set of users associated with the media content item, retrieving, at the server, for each user in the set of users, a set of index points along a timeline of the media content item, sending, to the user device, a response including the sets of index points, and providing, to the user device, the media content item.

A fifth exemplary embodiment provides a method that provides, at a user device, bookmarked media content. The exemplary method can include receiving, at the user device, a request for a media content item, requesting, from a server, sets of index points associated with the media content item, receiving, from the server, the sets of index points, and providing, at the user device, a set of user interface (UI) features indicating the position of the sets of index points within the media content item.

A sixth exemplary embodiment provides a user device that provides bookmarked media content. The exemplary user device can include a processor for executing a set of instructions, a memory, and/or non-transitory medium that stores the set of instructions. The set of instructions can be receiving, at the user device, a request for a media content item, requesting, from a server, sets of index points associated with the media content item, receiving, from the server, the sets of index points, and providing, at the user device, a set of user interface (UI) features indicating the position of the sets of index points within the media content item.

Several more detailed embodiments are described in the sections below. Section I provides a description of various UIs provided by some embodiments. Section II then describes system architectures of some embodiments. Next, Section III describes various processes used by some embodiments. Lastly, Section IV describes a computer system which implements some of the embodiments.

### I. User Interface

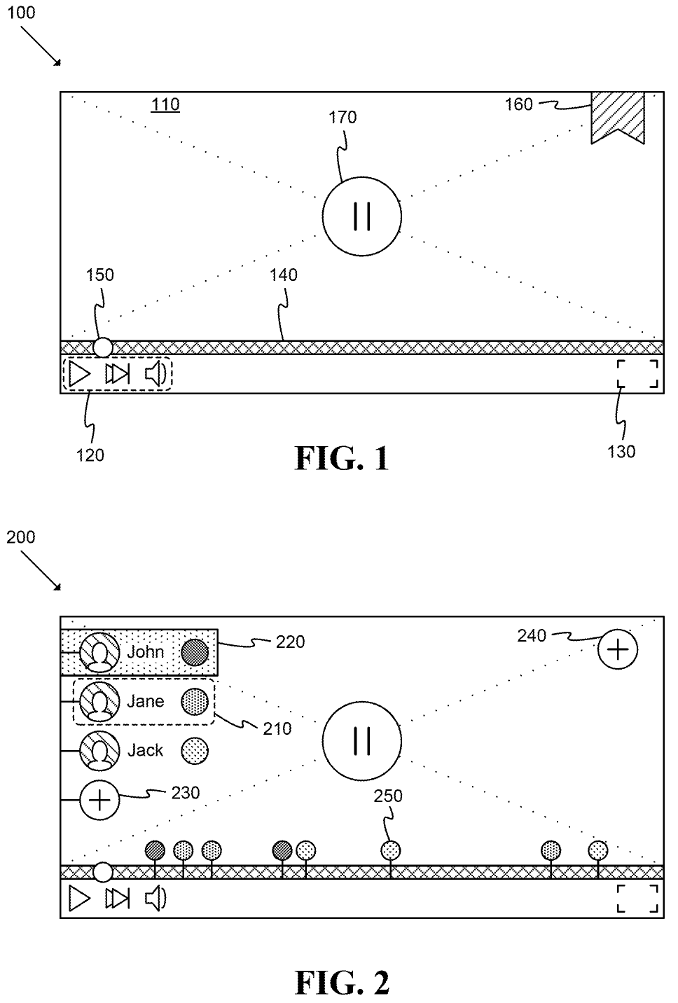

FIG. 1 illustrates an exemplary UI 100 of some embodiments that provides ways for users to interact with a multi-user bookmark environment. As shown, the UI 100 may include a content display area 110, various control elements 120-130, a timeline 140, a marker 150 various indicators or other selectable elements 160, and a pause/playback element 170. Such a UI 100 may be implemented within, for example, a web page via a browser plugin or other appropriate component. Alternatively, the UI 100 may be provided by a dedicated application.

The content display area 110 may provide video content. The display area 110 may be associated with various different attributes that may be defined or modified as appropriate (e.g., size, aspect ratio, etc.). In addition to video content, the display area 110 may be able to provide other types of graphical content (e.g., text, overlaid pictorial content, etc.). Some portion of the display area 110 may be used to provide other UI elements. Such elements may be invoked based on various relevant criteria (e.g., device motion, user input, etc.). The displayed content may be retrieved from various resources (e.g., local storage, content server, etc.) using various appropriate designators (e.g., a hyperlink, tag or ID, etc.).

The control elements 120-130 may include elements such as playback controls (e.g., play, next, volume, full-screen, etc.), social media controls (e.g., “like”, “share”, etc.), and/or other appropriate control elements.

The timeline 140 and marker 150 may be used to indicate a relative position within the content item. In addition, some embodiments may include other indicators (e.g., text-based indicators of current time, total time or play time, etc.). In addition, the timeline 140 and marker 150 may be used to select positions along the timeline 140 (e.g., by clicking a location along the timeline, by selecting and moving the marker 150 to a different location along the timeline 140, etc.).

The additional display elements or playback/pause indicators 170 may include, for example, a “pause” indicator as shown in this example, tags or links related to the content item or provider, and/or other appropriate elements.

The selectable element 160 may be used to invoke a multi-user bookmark interface of some embodiments. The element may be displayed, for example, when a video is paused, when a location within the UI 100 is selected or otherwise activated (e.g., by moving a cursor to an area of the display, by touching or hovering over an area of a touchscreen, etc.). The selectable element 160 may be represented using various graphic elements.

FIG. 2 illustrates an exemplary UI 200 of some embodiments that provides creation and use of bookmarks. UI 200 may be invoked using an element such as selectable element 160. In this example, the UI includes a number of user identifying elements 210, with one element including a selection indicator 220, an add user element 230, an add bookmark element 240, and a bookmark indicator 250.

The user identifying elements 210 may be selectable elements that are associated with a user. Such identifying elements may include text elements, graphic elements, etc. In this example, the identifying elements include user icons or photos, name, and a color associated with the user (with the “colors” represented by different fill patterns). Each identifying element 210 may be associated with a particular user or group of users (e.g., a team of employees that jointly define bookmarks within content). Some embodiments may allow modification of various aspects of the identifying elements. For instance, a viewer may be able to assign colors or other indicators, select icons to represent each user, update names, etc.

The inclusion of users or groups of users may be based on various relevant factors (e.g., user preference, default settings, available bookmarks, etc.). For instance, some viewers may elect to include all available users or select from among public user bookmarks (e.g., by selecting among professional critics, recommended users, and/or other types of users). As another example, a viewer may select from among available associated users (e.g., friends, associates, followers, etc. on various social media platforms). As still another example, the users and bookmarks may be associated with specific versions of the content (e.g., special editions with commentary, academic materials, etc.).

The selection indicator 220 may be any set of graphical elements that indicates a selected user, if appropriate. The graphical elements may include, for instance, shading, highlighting, and/or other appropriate indicators.

The add user element 230 may invoke additional UIs that allow selection of additional users from various sources (e.g., social media). Other elements may be included in some embodiments (e.g., “remove user”, “modify user”, etc.). The listing of users may be able to be modified in various other ways (e.g., the order of users may be modified, users may be “hidden”, etc.).

The add bookmark element 240 may invoke additional UIs that may be used to define a new bookmark. In some embodiments, the bookmark parameters may be collected automatically (e.g., based on an elapsed time of the current playback, based on the content source, etc.). Alternatively, a UI may be presented to allow a user to define the parameters associated with a bookmark (e.g., start time, end time, notes, etc.). Some embodiments may include additional elements (e.g., “remove bookmark”, “modify bookmark”, etc.). Such additional elements may be presented or not depending on user status. For instance, a user may be able to modify a bookmark created by that user, but not by other users.

Each bookmark indicator 250 may be a selectable element that includes a graphical representation associated with a user (e.g., a color). Each indicator may be associated with a bookmark. The indicators may be placed along the timeline 140 such that the position along the timeline corresponds to the content time associated with the bookmark. A viewer may be able to select from among the indicators in various ways (e.g., by clicking on an indicator, by tapping a touchscreen, etc.). Such an action may cause the playback of the content to jump to the time associated with the bookmark. In this example, the playback is indicated as being paused, however, such features may be used during active playback (e.g., the various UI elements may be invoked when a cursor is determined to be over the display area 110).

Some embodiments may generate UI elements by providing content information to a player or other appropriate resource. For instance, a bookmarked timeline may be generated by creating a timeline based on the play time of the content item. Index points associated with the bookmarks may then be added to the timeline information. The bookmarked timeline may then be supplied to the player.

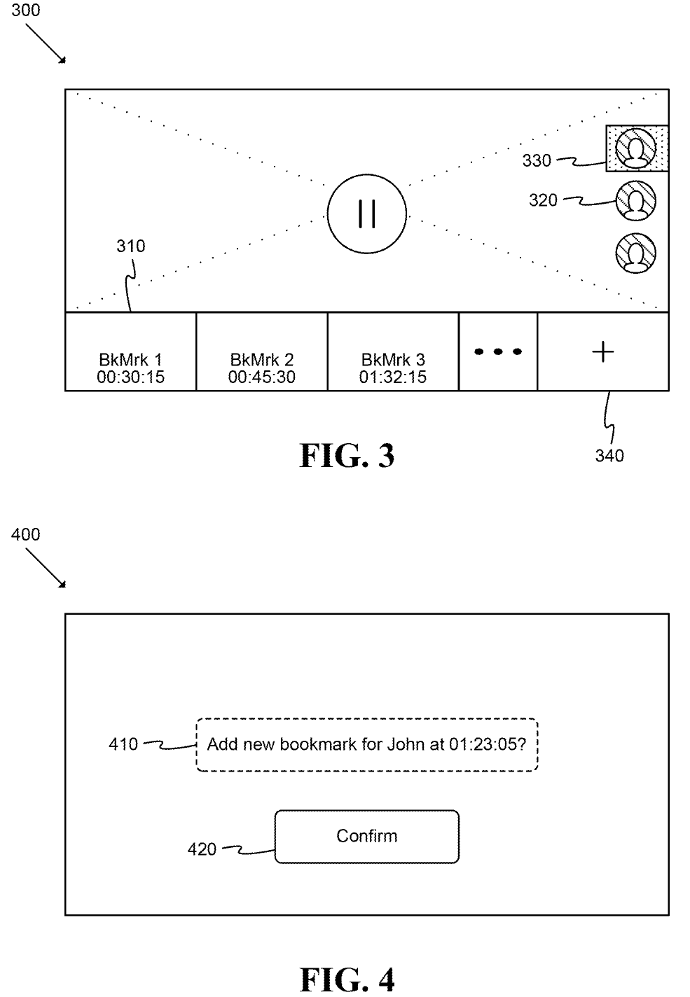

FIG. 3 illustrates an exemplary alternative UI 300 of some embodiments that provides creation and use of bookmarks. UI 300 may be invoked using an element such as selectable element 160. The determination of whether to use UI 200 or UI 300 may be made based on various relevant factors (e.g., user selection, default value, user preference, etc.). In this example, the UI 300 may present bookmarks associated with a single selected user. As shown, the UI 300 includes multiple bookmark indicators 310, a number of user identifying elements 320, with one element including a selection indicator 330, and an add bookmark element 340.

In this example, the selectable bookmark indicators 310 may include labels (e.g., bookmark ID, start time, etc.), thumbnail screen captures, and/or other appropriate elements. The selectable indicators may be arranged in a storyboard view as shown. When a selection is identified, the playback of the content item may jump to the location associated with the selected bookmark. The bookmark indicators obscure the timeline 140 and playback controls 120-130 described above, but may be removed from the display when a selection is made such that the controls and timeline 140 are visible.

The user identifying elements 320 include a picture in this example, but different components, or combinations thereof, may be used (e.g., text, graphics, etc.) as described above in reference to elements 210. The selection indicator 330 may be similar to indicator 220 described above. Add bookmark button 340 may be similar to add bookmark element 240 described above. UI 300 may include various other appropriate elements (e.g., add user, modify bookmark, etc.).

FIG. 4 illustrates an exemplary UI 400 of some embodiments that confirms bookmark creation. In this example, the UI includes a notification element 410 and a confirmation element 420. The user may be able to confirm that the details of the bookmark are correct before creating a bookmark. Different embodiments may include different information within the notification element 410 (and/or additional notification elements). The confirmation element 420 may be a selectable element that initiates creation of a bookmark.

Some embodiments may include additional UI elements. For instance, a user may be able to select a sharing type for a bookmark (or set of bookmarks) such as “public”, “private”, “share with specific people”, etc. As another example, some embodiments may include data entry fields that may allow a user to define various attributes of the bookmark (e.g., name, graphical representations, thumbnail image, etc.).

One of ordinary skill in the art will recognize that the UIs and UI elements described above in reference to FIGS. 1-4 may be implemented in various different ways without departing from the scope of the disclosure. For instance, different embodiments may include additional elements, omit various elements, rearrange the elements, and/or otherwise change the presentation of the various elements. In addition, the various specific UI elements may be represented in various different ways (e.g., using different graphics or icons than shown, using text, etc.).

### II. System Architecture

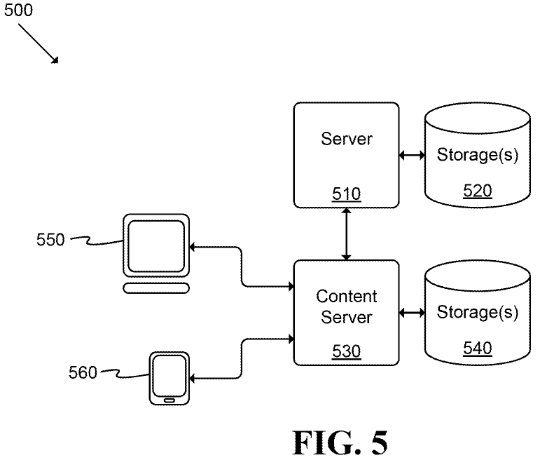

FIG. 5 illustrates a schematic block diagram of a hardware system 500 used by some embodiments to provide the multi-user bookmark environment. As shown, the system may include a server 510 with associated storages 520, a content server 530 with associated storages 540, and various types of user devices 550-560.

The server 510 may be a computing device that is able to execute instructions and/or process data. The server may be able to access other system elements via various communication pathways (e.g., wired connections, local area wireless connections, etc.) and using various appropriate networks (e.g., local area networks, cellular networks, the Internet, etc.). Storage 520 may be a device capable of receiving, storing, and/or providing instructions and/or data. Storage 520 can be a memory that includes a disk drive, a hard drive, RAM, ROM, optical storage, solid state memory, DRAM, and the like.

Content server 530 and storage 540 may be similar to server 510 and storage 520. The content server 530 may be associated with various third-party content sources (e.g., social media platforms, multimedia web sites, etc.) while server 510 may be associated with the bookmarking environment of some embodiments. In some cases, servers 510 and 530 may be implemented using one computing device (and/or an associated set of computing devices). In some embodiments, content server 530 may interact with server 510 (and/or storage 520) via one or more application programming interfaces (APIs). Storage 540 can be a memory that includes a disk drive, a hard drive, RAM, ROM, optical storage, solid state memory, DRAM, and the like.

The user devices 550-560 may include various device types (e.g., personal computers, tablets, smartphones, etc.). Such devices may be able to access the servers 510 and/or 530 using various communication pathways and/or networks.

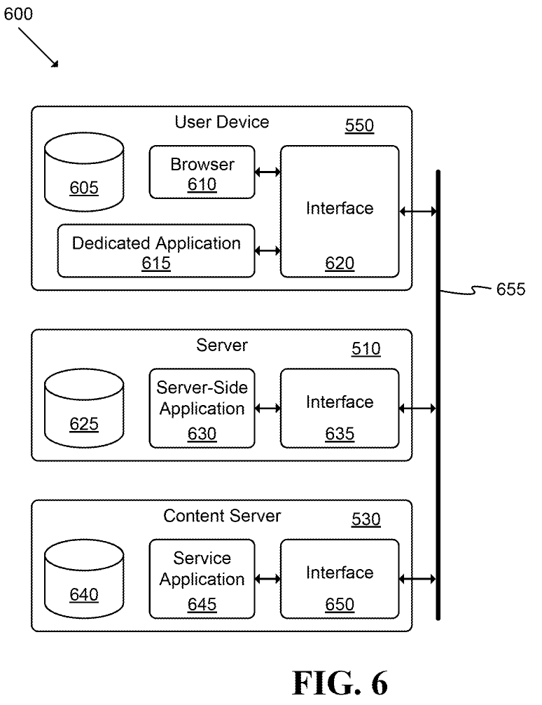

FIG. 6 illustrates a schematic block diagram of a software system 600 used by some embodiments to provide the multi-user bookmark environment. Such a system may be implemented using system 500 described above. Although various elements of system 600 may be described as software, one of ordinary skill in the art will recognize that various combinations of electronic circuitry may, alternatively and/or conjunctively, be used to implement various features described in reference to system 600.

This example includes user device 550, server 510, and content server 530. As shown, the user device 550 includes a storage element 605, a browser 610, a dedicated application 615, and an interface 620. The server 510 includes a storage 625, a server-side application 630, and an interface 635. The content server 530 includes a storage 640, a servicer or provider application 645, and an interface 650.

Storages 605, 625, and 640 may be able to store data locally for use by the other elements. The interfaces 620, 635, and 650 may be able to communicate across bus 655, where the bus may include various communication channels and/or network connections.

The browser 610 and/or dedicated application 615 may be used by some embodiments to provide the UIs 100-400 described above. The browser 610 may allow access to various websites that provide content using the multi-user bookmark environment of some embodiments. The dedicated application 615 may include a media player and/or other appropriate elements that allow a user to receive content and generate or utilize bookmarks.

The server-side application 630 may manage bookmarks in various appropriate ways (e.g., by storing bookmark information, by providing bookmark information to content providers, etc.). The server-side application 630 may be able to interact with the browser 610 and/or dedicated application 615 as appropriate.

The service application 645 may provide content to viewers. The service application may be able to interact with the browser 610, dedicated application 615, and/or server-side application 630 in order to create and utilize bookmarks provided by some embodiments.

One of ordinary skill in the art will recognize that the systems of FIGS. 5-6 are exemplary and different embodiments may be implemented in various different ways without departing from the scope of the disclosure. For instance, some embodiments may include additional elements or omit some elements. As another example, different embodiments may combine or divide various elements. In addition, multiple instances of any elements may be included.

### III. Methods of Operation

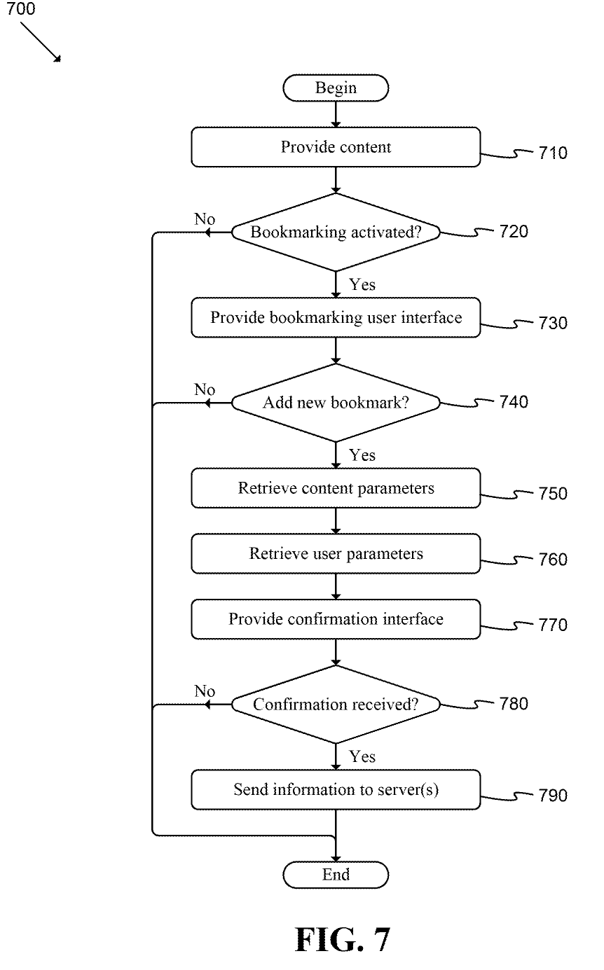

FIG. 7 illustrates a flow chart of an exemplary client-side process 700 used by some embodiments to generate a bookmark. Such a process may be executed by a device such as user device 550 or 560, which may utilize elements such as browser 610 or dedicated application 615, and/or UIs 100-400. The process may begin, for instance, when a viewer accesses content associated with the multi-user bookmark environment of some embodiments.

As shown, the process may provide (at 710) content. Such content may be retrieved from a resource such as content server 530 or server 510 and displayed using a UI similar to UI 100 described above. A user may be able to at least partly control the provision of content (e.g., by starting or pausing playback, by selecting specific points along a timeline, etc.).

Next, the process may determine (at 720) whether a bookmark feature of some embodiments has been activated. Such a feature may be activated using an element such as element 160 described above. If the process determines (at 720) that the bookmark feature has not been activated, the process may end.

If the process determines (at 720) that the bookmark feature has been activated, the process may then provide (at 730) a bookmarking UI. Such a UI may be similar to UI 200 or UI 300 described above. If the process determines (at 720) that the bookmark feature has not been activated, the process may end.

After providing (at 730) the bookmarking UI, the process may determine (at 740) whether a new bookmark has been added. Such a determination may be made based at least partly on inputs received via the UI 200 or 300. If the process determines (at 740) that no new bookmark has been added, the process may end.

If the process determines (at 740) that a new bookmark has been added, the process may then retrieve (at 750) various content parameters. Such parameters may include current time along a timeline (or “play time”), capture of a thumbnail image associated with the video frame at the current time along the timeline, content ID, content source, etc. The current time may be associated with an elapsed time and may be specified in various different ways. In some embodiments the “time” may refer to a frame or other appropriate element rather than being directly associated with any elapsed time.

Next, the process may retrieve (at 760) various user parameters (e.g., user name, user affiliations, etc.). Such user parameters may relate to various social platform features associated with the user (e.g., group membership, demographic information, etc.). The user parameters may also include default settings such as sharing level, graphical features, etc.

The process may then provide (at 770) a confirmation interface such as UI 400. The confirmation interface may include various notifications, parameter listings, etc. In addition, a confirmation button or other appropriate selectable element may be provided such that a user can confirm submission of a bookmark.

If the process determines (at 780) that no confirmation was received, the process may end. If the process determines (at 780) that a confirmation was received, the process may send (at 790) the bookmark information to the server(s) (e.g., server 510 and/or server 530).

Process 700 (and/or portions thereof) may be performed iteratively, to allow multiple users to each generate multiple bookmarks.

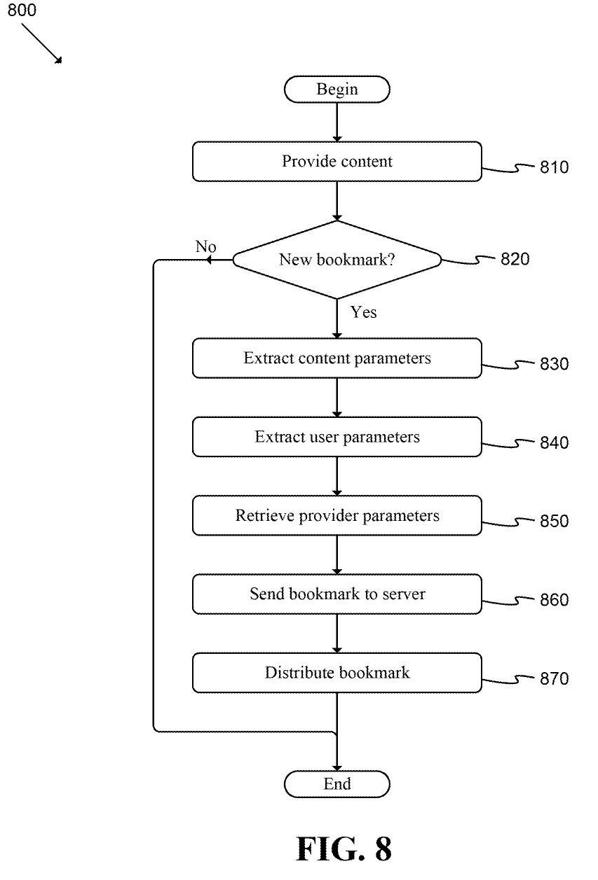

FIG. 8 illustrates a flow chart of an exemplary provider-side process 800 used by some embodiments to generate a bookmark. Such a process may be executed by a device such as content server 530, which may utilize elements such as service application 645. Process 800 may be executed as a complement to process 700. Process 800 may begin, for instance, when a viewer accesses content associated with the multi-user bookmark environment of some embodiments.

As shown, the process may provide (at 810) content. Such content may be provided via a web browser and/or dedicated application. The content may be provided by sending multimedia data to a user device of some embodiments.

Next, the process may determine (at 820) whether a new bookmark has been created. Such a determination may be made based on various relevant factors. For instance, such a determination may be made based on whether a selection of item 240 or item 340 has been made. If the process determines (at 820) that no new bookmark has been added the process may end.

If the process determines (at 820) that a new bookmark has been added, the process may then extract (at 830) content parameters. Such parameters may include, for instance, an index point along the timeline, a content ID, a hyperlink to the content source, etc. The parameters may be extracted from a message received from a user device or server. Alternatively, a communication channel may be established in order to allow the content server 530 to send and receive communications with the user device 550 or 560 or server 510.

Next, the process may extract (at 840) user parameters. Alternatively, the parameters may be requested from another resource. Such parameters may include, for instance, user ID, sharing settings, etc.

The process may then retrieve (at 850) provider parameters. Such parameters may be retrieved from a local storage and may include, for instance, provider ID, group or user information, etc.

Next, the process may define and send (at 860) the bookmark information to the server. Such definition may be based at least partly on the content parameters, user parameters, and/or provider parameters. The bookmark may also be stored locally and/or sent to other resources, such as a user device.

The process may then distribute (at 870) the bookmark, if appropriate, and then may end. The distribution of the bookmark may be based on various relevant factors. For instance, a user may belong to a social network group that shares bookmarks among members of the group. As another example, the bookmark may be distributed to a specific list of users. Distribution may include sending the bookmark information to user devices associated with other users, for example, when another user accesses the content.

Process 800 (and/or portions thereof) may be performed iteratively, to allow multiple users to each generate multiple bookmarks.

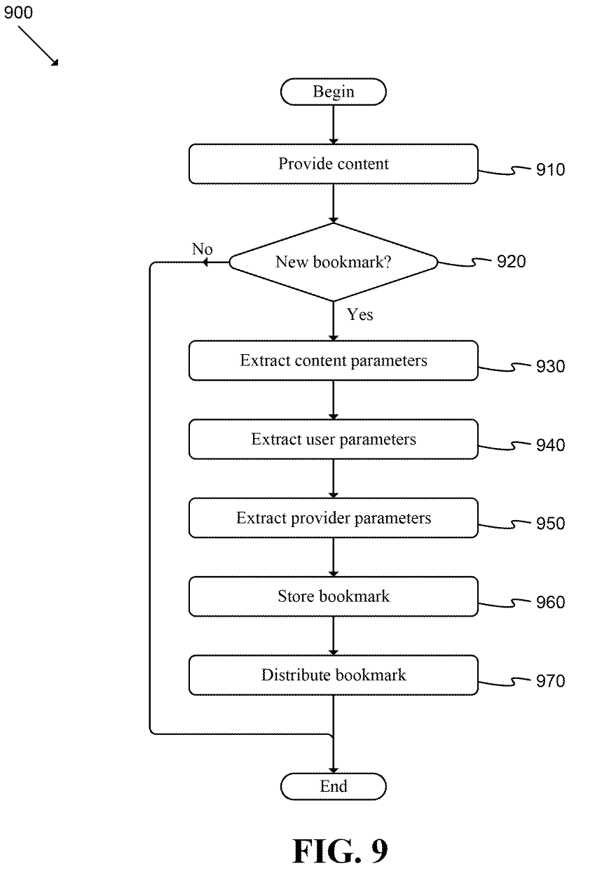

FIG. 9 illustrates a flow chart of an exemplary server-side process 900 used by some embodiments to generate a bookmark. Such a process may be executed by a device such as server 510, which may utilize elements such as server-side application 630. Process 900 may be executed as a complement to processes 700 and/or 800. Processes 800 and 900 may be performed conjunctively, and/or by a single server. Process 900 may begin, for instance, when a viewer accesses content associated with the multi-user bookmark environment of some embodiments.

As shown, the process may provide (at 910) content. Such content may be provided to a user device or other resource (e.g., a content server). Alternatively, the content may be provided by another resource (e.g., a content server).

Next, the process may determine (at 920) whether to create a new bookmark. Such a determination may be made based on requests received from other system resources such as a user device or content server. If the process determines (at 920) that no bookmark is to be created, the process may end.

If the process determines (at 920) that a bookmark is to be created, the process may extract (at 930) content parameters, extract (at 940) user parameters, and extract (at 950) provider parameters. Such parameters may be extracted from a message or other received communication. In some cases, some or all parameters may be requested from the other resources during a two-way communication.

Next, the process may define and store (at 960) the bookmark. Alternatively, the bookmark definition may be received from another resource and stored by the server (in such cases, operations 930-950 may be omitted). In some cases, the bookmark information may be embedded into the content item itself.

The process may then distribute (at 970) the bookmark, if appropriate, and then may end. For instance, the bookmark may be distributed to other resources such as a user device or content server.

Process 900 (and/or portions thereof) may be performed iteratively, to allow multiple users to each generate multiple bookmarks.

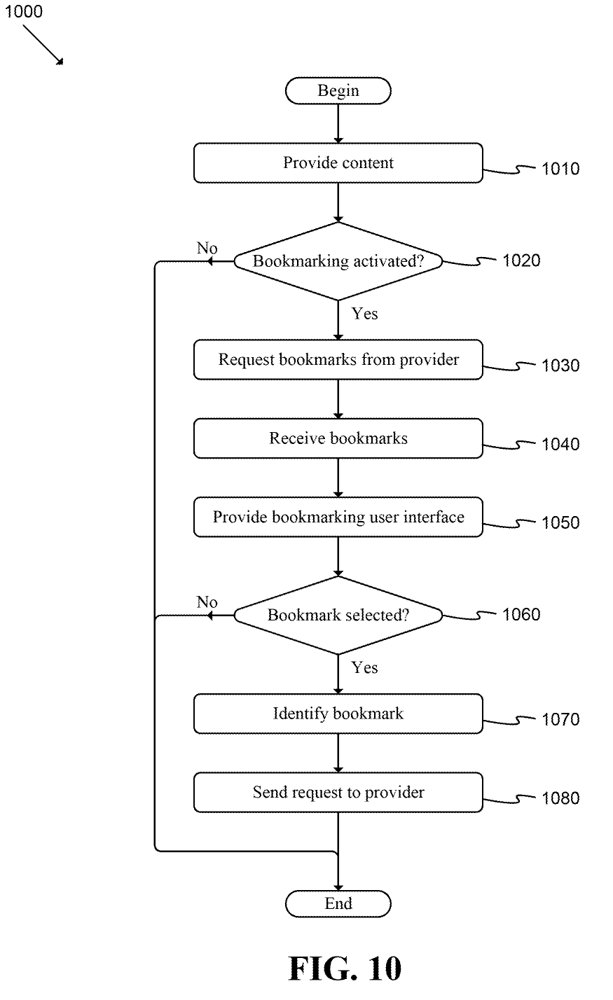

FIG. 10 illustrates a flow chart of an exemplary client-side process 1000 used by some embodiments to utilize bookmarks within a multi-user bookmark environment. Such a process may be executed by a device such as user device 550 or 560, which may utilize elements such as browser 610 or dedicated application 615, and/or UIs 100-400. The process may begin, for instance, when a viewer accesses content associated with the multi-user bookmark environment of some embodiments.

As shown, the process may provide (at 1010) content. Such content may be provided in conjunction with and/or by other system elements such as a content server and/or other server.

Next, the process may determine (at 1020) whether bookmarking has been activated. In some cases, such bookmarking may be automatically activated based on various relevant factors (e.g., user preferences, default settings, content type, etc.). Alternatively, the determination may be made based on received inputs, such as selection of element 160 by a viewer. If the process determines (at 1020) that bookmarking has not been activated, the process may end.

If the process determines (at 1020) that bookmarking has been activated, the process may then request (at 1030) bookmarks associated with the content from the content provider and then receive (at 1040) the bookmarks. Alternatively, the bookmarks may be included with the content item and extracted by process 1000.

Next, the process may provide (at 1050) a bookmarking UI, such as UI 200 or UI 300. Providing the UI may include generating a timeline for the content item (or “media asset”). The timeline may comport to the play time of the content item. Index points along the timeline may then be generated. Such index points (or “bookmarks”) may be related to multiple different users.

The process may then determine (at 1060) whether a bookmark has been selected. Such a selection may involve a viewer selecting an element such as indicator 250 or indicator 310. If the process determines (at 1060) that no bookmark has been selected, the process may end.

If the process determines (at 1060) that a bookmark has been selected, the process may identify (at 1070) the bookmark. Such identification may include various references and/or parameters associated with the bookmark.

Next, the process may send (at 1080) a request to the content provider indicating the selection of the bookmark and then may end. The content provider may then respond to the bookmark selection (e.g., by jumping to the specified index point within a streaming content item). Alternatively, the process may jump to the bookmark location without involving the content provider (e.g., when a content item and associated bookmarks have been downloaded to a user device).

Process 1000 (and/or portions thereof) may be performed iteratively, to allow multiple bookmarks to be selected, to allow multiple invocations of the bookmark UI, etc.

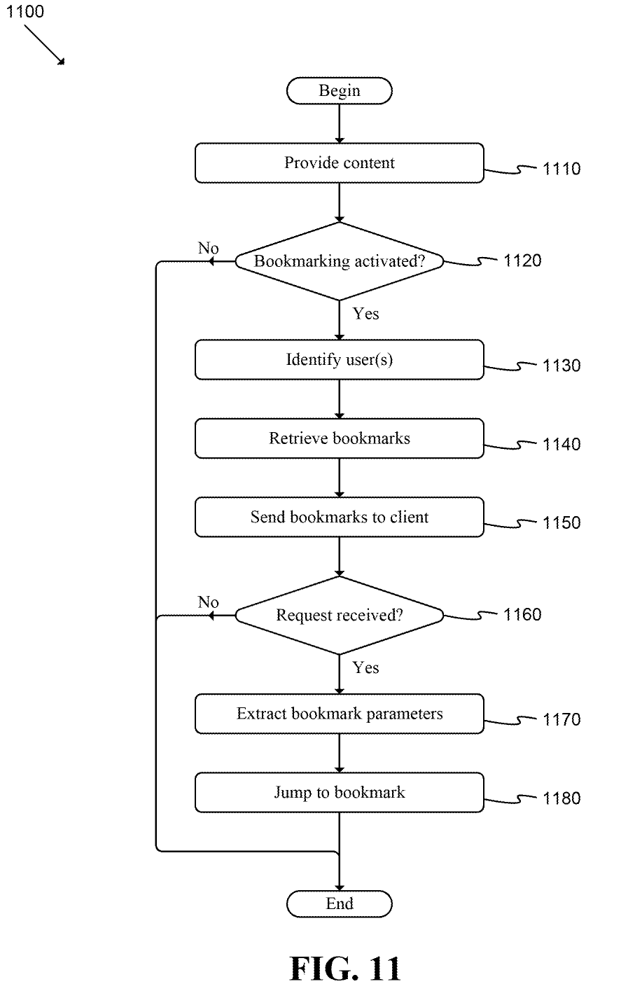

FIG. 11 illustrates a flow chart of an exemplary provider-side process 1100 used by some embodiments to utilize bookmarks within a multi-user bookmark environment. Such a process may be executed by a device such as content server 530, which may utilize elements such as service application 645. Process 1100 may be executed as a complement to process 1000. Process 1100 may begin, for instance, when a viewer accesses content associated with the multi-user bookmark environment of some embodiments.

As shown, the process may provide (at 1110) content. Such content may be provided in conjunction with other system elements such as another server.

Next, the process may determine (at 1120) whether bookmarking has been activated. In some cases, such bookmarking may be automatically activated based on various relevant factors (e.g., user preferences, default settings, content type, etc.). Alternatively, the determination may be made based on communications with a user device and/or server. If the process determines (at 1120) that bookmarking has not been activated, the process may end.

If the process determines (at 1120) that bookmarking has been activated, the process may then identify (at 1130) users associated with the viewer (and/or content) and then retrieve (at 1140) the bookmarks associated with those users. The bookmarks may be retrieved from a local storage or a remote resource such as server 510. Alternatively, the bookmarks may be included with the content item and extracted by process 1100.

Next, the process may send (at 1150) the retrieved bookmarks to the client or user device associated with the viewer. The process may then determine (at 1160) whether a bookmark selection request has been received. Such a selection request may be sent as a result of a viewer selecting an element such as indicator 250 or indicator 310. If the process determines (at 1160) that no request has been received, the process may end.

If the process determines (at 1160) that a request has been received, the process may extract (at 1170) the bookmark parameters (and/or otherwise obtain the information such as from a local storage or remote server).

Next, the process may jump (at 1180) to the specified index point within a streaming content item and/or otherwise execute other actions related to the bookmark selection. Alternatively, the process may send commands, instructions, and/or data to a user device player such that the appropriate actions are undertaken.

Process 1100 (and/or portions thereof) may be performed iteratively, to allow multiple bookmarks to be selected, to allow multiple users to access content, etc.

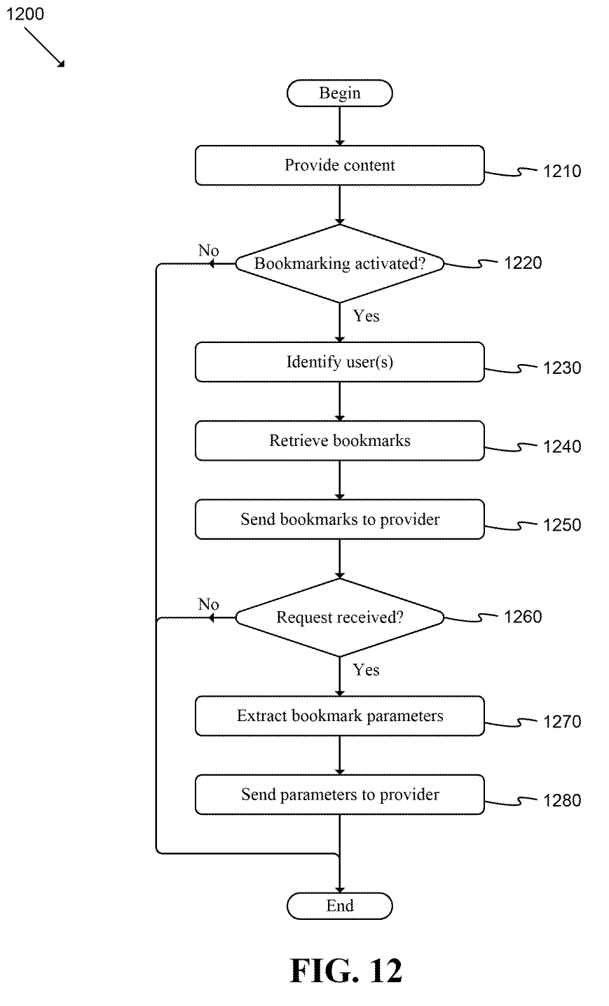

FIG. 12 illustrates a flow chart of an exemplary server-side process 1200 used by some embodiments to utilize bookmarks within a multi-user bookmark environment. Such a process may be executed by a device such as server 510, which may utilize elements such as server-side application 630. Process 1200 may be executed as a complement to processes 1000 and/or 1100. Processes 1100 and 1200 may be performed conjunctively, and/or by a single server. The process may begin, for instance, when a viewer accesses content associated with the multi-user bookmark environment of some embodiments.

As shown, the process may provide (at 1210) content. Such content may be provided in conjunction with other system elements such as a content server.

Next, the process may determine (at 1220) whether bookmarking has been activated. In some cases, such bookmarking may be automatically activated based on various relevant factors (e.g., user preferences, default settings, content type, etc.). Alternatively, the determination may be made based on communications with a user device and/or content server. If the process determines (at 1220) that bookmarking has not been activated, the process may end.

If the process determines (at 1220) that bookmarking has been activated, the process may then identify (at 1230) users associated with the viewer (and/or content) and then retrieve (at 1240) the bookmarks associated with those users. The bookmarks may be retrieved from a local storage or a remote resource such as content server 530 or even user device 550 or 560. Alternatively, the bookmarks may be included with the content item and extracted by process 1200.

Next, the process may send (at 1250) the retrieved bookmarks to the content server associated with the content provider. Alternatively, the bookmarks may be sent to a client or user device associated with the viewer. The process may then determine (at 1260) whether a bookmark selection request has been received. Such a selection request may be sent as a result of a viewer selecting an element such as indicator 250 or indicator 310 and may be received from a user device or content server. If the process determines (at 1260) that no request has been received, the process may end.

If the process determines (at 1260) that a request has been received, the process may extract (at 1270) the bookmark parameters (and/or otherwise obtain the information such as from a local storage or other server).

Next, the process may send (at 1280) the bookmark parameters to the content provider such that the provider may execute the bookmark actions. Alternatively, the process may jump to the bookmark location when providing the content from the server 530. As another example, the process may send commands, instructions, and/or data to a user device such that the appropriate actions are undertaken.

Process 1200 (and/or portions thereof) may be performed iteratively, to allow multiple bookmarks to be selected, to allow multiple users or providers, to access content, etc.

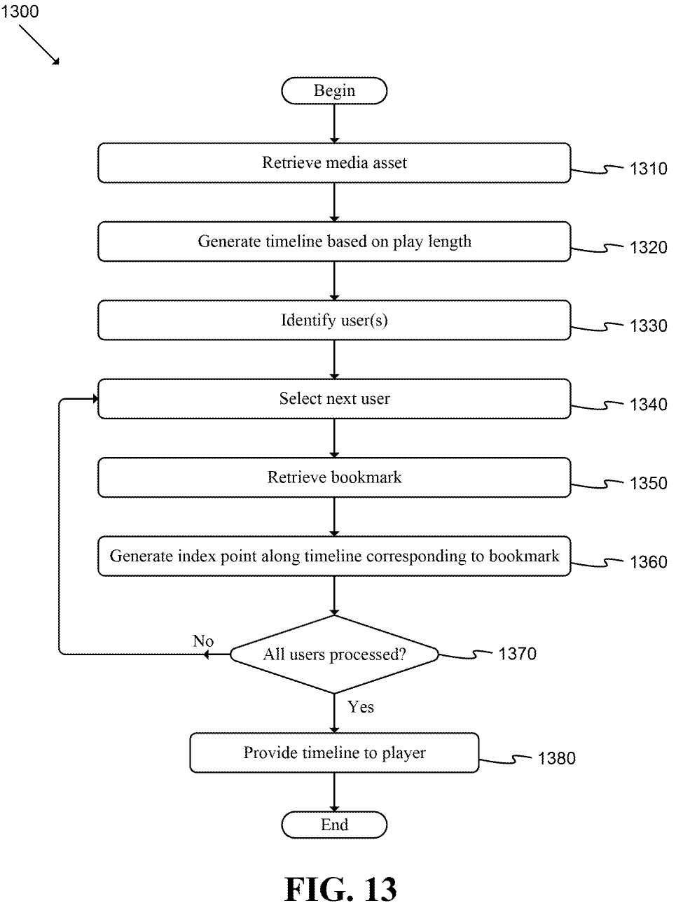

FIG. 13 illustrates a flow chart of an exemplary process 1300 used by some embodiments to generate a timeline for user with a multi-user bookmark environment. Such a process may be executed by a device such as server 510, content server 530, user device 550, user device 560, and/or other appropriate elements. Process 1300 may be executed as a complement to processes 1000-1200. The process may begin, for instance, when a viewer accesses content associated with the multi-user bookmark environment of some embodiments.

As shown, the process may retrieve (at 1310) a media asset for playback. Next, the process may generate (at 1320) a timeline based on the play length of the media asset. The process may then identify (at 1330) a list of users associated with the media asset.

The process may then select (at 1340) the next user from the list of identified users. The process may then retrieve (at 1350) a set of bookmarks associated with the user and generate (at 1360) an index point along the timeline corresponding to each bookmark in the set.

Next, the process may determine (at 1370) whether all users in the list of been processed. If the process determines (at 1370) that not all users have been processed, the process may repeat operations 1340-1370 until the process determines (at 1370) that all users have been processed.

Process 1300 may then provide (at 1370) the timeline to the player and then end. The modified timeline may be stored and/or associated with or embedded into the media asset.

One of ordinary skill in the art will recognize that the example processes described above in reference to FIGS. 7-13 may be implemented in various different ways without departing from the scope of the disclosure. For instance, different embodiments may perform the operations in different orders than described. As another example, some embodiments may include additional operations and/or omit various listed operations. Each process may be divided into multiple sub-processes and/or combined with other processes to form macro processes. In addition, sub-sets of operations may be performed iteratively based on various appropriate criteria. Furthermore, multiple instances of each processes and/or portions thereof may be performed in parallel such that multiple users may access and utilize the bookmark environment of some embodiments.

### IV. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

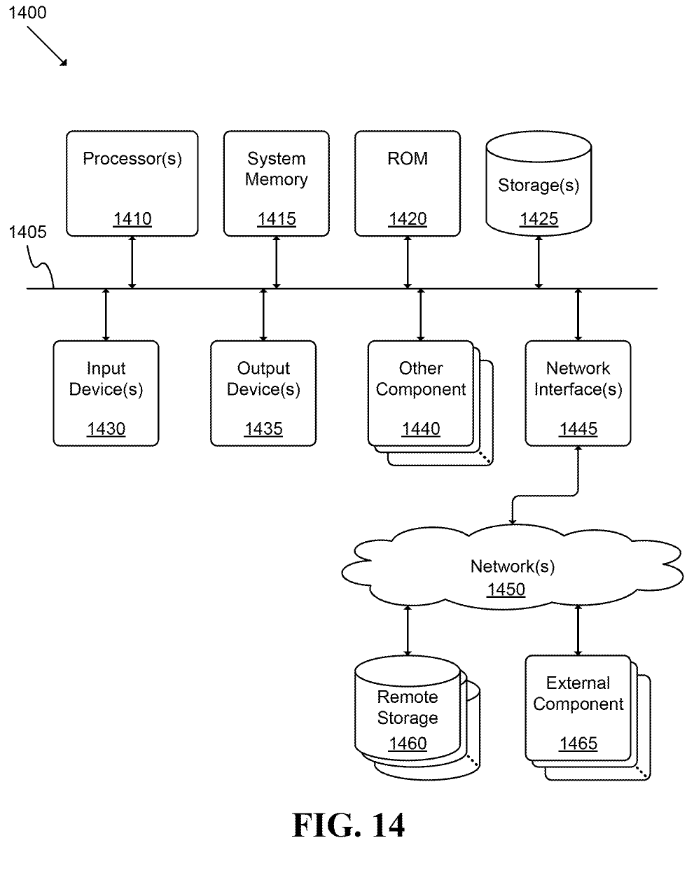

FIG. 14 illustrates a schematic block diagram of an exemplary computer system 1400 used to implement some embodiments. For example, the system described above in reference to FIGS. 5 and 6 may be at least partially implemented using computer system 1400. As another example, the processes described in reference to FIGS. 7-12 may be at least partially implemented using sets of instructions that are executed using computer system 1400.

Computer system 1400 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 1400 may include at least one communication bus 1405, one or more processors 1410, a system memory 1415, a read-only memory (ROM) 1420, permanent storage devices 1425, input devices 1430, output devices 1435, various other components 1440 (e.g., a graphics processing unit), and one or more network interfaces 1445.

Bus 1405 represents all communication pathways among the elements of computer system 1400. Such pathways may include wired, wireless, optical, and/or other appropriate communication pathways. For example, input devices 1430 and/or output devices 1435 may be coupled to the system 1400 using a wireless connection protocol or system.

The processor 1410 may, in order to execute the processes of some embodiments, retrieve instructions to execute and/or data to process from components such as system memory 1415, ROM 1420, and permanent storage device 1425. Such instructions and data may be passed over bus 1405.

System memory 1415 may be a volatile read-and-write memory, such as a random access memory (RAM). The system memory may store some of the instructions and data that the processor uses at runtime. The sets of instructions and/or data used to implement some embodiments may be stored in the system memory 1415, the permanent storage device 1425, and/or the read-only memory 1420. ROM 1420 may store static data and instructions that may be used by processor 1410 and/or other elements of the computer system.

Permanent storage device 1425 may be a read-and-write memory device. The permanent storage device may be a non-volatile memory unit that stores instructions and data even when computer system 1400 is off or unpowered. Computer system 1400 may use a removable storage device and/or a remote storage device as the permanent storage device.

Input devices 1430 may enable a user to communicate information to the computer system and/or manipulate various operations of the system. The input devices may include keyboards, cursor control devices, audio input devices and/or video input devices. Output devices 1435 may include printers, displays, and/or audio devices. Some or all of the input and/or output devices may be wirelessly or optically connected to the computer system.

Other components 1440 may perform various other functions. These functions may include performing specific functions (e.g., graphics processing, sound processing, etc.), providing storage, interfacing with external systems or components, etc.

Finally, as shown in FIG. 14, computer system 1400 may be coupled to one or more networks 1450 through one or more network interfaces 1445. For example, computer system 1400 may be coupled to a web server on the Internet such that a web browser executing on computer system 1400 may interact with the web server as a user interacts with an interface that operates in the web browser. Computer system 1400 may be able to access one or more remote storages 1460 and one or more external components 1465 through the network interface 1445 and network 1450. The network interface(s) 1445 may include one or more application programming interfaces (APIs) that may allow the computer system 1400 to access remote systems and/or storages and also may allow remote systems and/or storages to access computer system 1400 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1400 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1. A method that generates, at a user device, a media asset timeline, the method comprising:
generating a timeline comporting to a play length of the media asset;
generating a first set of index points along the timeline, wherein the first set of index points is associated with a first user; and
generating a second set of index points along the timeline, wherein the second set of index points is associated with a second user.

2. The method of claim 1, wherein the media asset comprises video content.

3. The method of claim 1, wherein each index point in the first set of index points has a position along the timeline defined by the first user and each index point in the second set of index points has a position along the timeline defined by the second user.

4. The method of claim 1 further comprising providing the timeline and sets of index points to a media player.

5. The method of claim 1 further comprising:
receiving a selection of a particular index point; and
proceeding to a point in the media asset corresponding to the particular index point.

6. A user device that generates a media asset timeline, the user device comprising:
a processor for executing a set of instructions; and
a memory that stores the set of instructions, wherein the set of instructions:
generating a timeline comporting to a play length of the media asset;
generating a first set of index points along the timeline, wherein the first set of index points is associated with a first user; and
generating a second set of index points along the timeline, wherein the second set of index points is associated with a second user.

7. The user device of claim 6, wherein the media asset comprises video content.

8. The user device of claim 6, wherein each index point in the first set of index points has a position along the timeline defined by the first user and each index point in the second set of index points has a position along the timeline defined by the second user.

9. The user device of claim 6, wherein the set of instructions further provides the timeline and sets of index points to a media player.

10. The user device of claim 6, wherein the set of instructions further:
receiving a selection of a particular index point; and
proceeding to a point in the media asset corresponding to the particular index point.

11. A method that provides, at a server, bookmarked media content, the method comprising:
receiving, from a user device, a request for a media content item;
identifying, at the server, a set of users associated with the media content item;
retrieving, at the server, for each user in the set of users, a set of index points along a timeline of the media content item;
sending, to the user device, a response including the sets of index points; and
providing, to the user device, the media content item.

12. The method of claim 11 further comprising:
receiving, from the user device, a selection of a particular index point; and
proceeding to a playback location of the media content item associated with the particular index point.

13. The method of claim 11 further comprising:
receiving, from the user device, a request to add an index point;
defining the index point based on a set of parameters received from the user device; and
including the index point in at least one set of index points.

14. A server that provides bookmarked media content, the server comprising:
a processor for executing a set of instructions; and
a memory that stores the set of instructions, wherein the set of instructions comprising:
receiving, from a user device, a request for a media content item;
requesting, at the server, a set of users associated with the media content item;
retrieving, at the server, for each user in the set of users, a set of index points along a timeline of the media content item;
sending, to the user device, a response including the sets of index points; and
provides, to the user device, the media content item.

15. The server of claim 14, wherein the set of instructions further comprising:
receiving, from the user device, a selection of a particular index point; and
proceeding to a playback location of the media content item associated with the particular index point.

16. The server of claim 14, wherein the set of instructions further comprising:
receiving, from the user device, a request to add an index point;
defining the index point based on a set of parameters received from the user device; and
including the index point in at least one set of index points

17. A method that provides, at a user device, bookmarked media content, the method comprising:
receiving, at the user device, a request for a media content item;
requesting, from a server, sets of index points associated with the media content item;
receiving, from the server, the sets of index points; and
providing, at the user device, a set of user interface (UI) features indicating the position of the sets of index points within the media content item.

18. The method of claim 17 further comprising:
receiving, at the user device, a selection of a particular index point; and
sending, to the server, a request to proceed to the particular index point.

19. The method of claim 17 further comprising:
receiving, at the user device, a selection of an add index point UI feature;
retrieving, at the user device, a set of content parameters;
retrieving, at the user device, a set of user parameters; and
sending, to the server, a request to generate an index point, the request including at least one of the set of content parameters and the set of user parameters.

20. A user device that provides bookmarked media content, the user device comprising:
a processor for executing a set of instructions; and
a memory that stores the set of instructions, wherein the set of instructions comprising:
receiving, at the user device, a request for a media content item;
requesting, from a server, sets of index points associated with the media content item;
receiving, from the server, the sets of index points; and
providing, at the user device, a set of user interface (UI) features indicating the position of the sets of index points within the media content item.

21. The user device of claim 20, wherein the set of instructions further comprising:
receiving, at the user device, a selection of a particular index point; and
sending, to the server, a request to proceed to the particular index point.

22. The user device of claim 20, wherein the set of instructions further comprising:
receiving, at the user device, a selection of an add index point UI feature;
retrieving, at the user device, a set of content parameters;
retrieving, at the user device, a set of user parameters; and
sending, to the server, a request to generate an index point, the request including at least one of the set of content parameters and the set of user parameters.
